(19) United States
(12) Patent Application Publication
(10) Pub. No.: US 2024/0397461 A1
(43) Pub. Date: Nov. 28, 2024

(54) HANDLING A FIRST TIMING ADVANCE TIMER AND A SECOND TIMING ADVANCE TIMER

(71) Applicant: QUALCOMM Incorporated, San Diego, CA (US)

(72) Inventors: Ruiming ZHENG, Beijing (CN); Jing LEI, San Diego, CA (US); Linhai HE, San Diego, CA (US)

(21) Appl. No.: 18/686,324

(22) PCT Filed: Oct. 22, 2021
(86) PCT No.: PCT/CN2021/125494

§ 371 Date: Feb. 23, 2024

(51) Int. Cl. H04W 56/00; H04W 74/0833; H04W 76/20

(52) U.S. Cl. CPC H04W 56/0045; H04W 74/0833; H04W 76/20

(57) ABSTRACT

Various aspects of the present disclosure generally relate to wireless communication. In some aspects, a user equipment (UE) may receive a configuration of a first timing advance timer associated with a first type of communication having a first size. The UE may select a timing advance timer from the first timing advance timer and a second timing advance timer that is associated with a second type of communication having a size that is greater than the first size. The UE may transmit a communication of the first type of communication based at least in part on the selected timing advance timer. Numerous other aspects are described.

### FIELD OF THE DISCLOSURE

Aspects of the present disclosure generally relate to wireless communication and to techniques and apparatuses for handling a first timing advance timer and a second timing advance timer.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration of a first timing advance timer associated with a first type of communication having a first size. The method may include select a timing advance timer from the first timing advance timer and a second timing advance timer that is associated with a second type of communication having a size that is greater than the first size. The method may include transmitting a communication of the first type of communication based at least in part on the selected timing advance timer.

Some aspects described herein relate to a method of wireless communication performed by a base station. The method may include transmitting configuration information for a first timing advance timer associated with a first type of communication having a first size. The method may include receiving the first type of communication based at least in part on the first timing advance timer or a second timing advance timer that is associated with a second type of communication having a size that is greater than the first size.

Some aspects described herein relate to an apparatus for wireless communication performed by a UE. The apparatus may include a memory and one or more processors, coupled with the memory. The one or more processors may be configured to receive a configuration of a first timing advance timer associated with a first type of communication having a first size. The one or more processors may be configured to select a timing advance timer from the first timing advance timer and a second timing advance timer that is associated with a second type of communication having a size that is greater than the first size. The one or more processors may be configured to transmit the a communication of the first type of communication based at least in part on the selected timing advance timer.

Some aspects described herein relate to an apparatus for wireless communication performed by a base station. The apparatus may include a memory and one or more processors, coupled with the memory. The one or more processors may be configured to transmit configuration information for a first timing advance timer associated with a first type of communication having a first size. The one or more processors may be configured to receive the first type of communication based at least in part on the first timing advance timer or a second timing advance timer that is associated with a second type of communication having a size that is greater than the first size.

Some aspects described herein relate to a non-transitory computer-readable medium that stores a set of instructions for wireless communication by a UE. The set of instructions, when executed by one or more processors of the UE, may cause the UE to receive a configuration of a first timing advance timer associated with a first type of communication having a first size. The set of instructions, when executed by one or more processors of the UE, may cause the UE to select a timing advance timer from the first timing advance timer and a second timing advance timer that is associated with a second type of communication having a size that is greater than the first size. The set of instructions, when executed by one or more processors of the UE, may cause the UE to transmit a communication of the first type of communication based at least in part on the selected timing advance timer.

Some aspects described herein relate to a non-transitory computer-readable medium that stores a set of instructions for wireless communication by a base station. The set of instructions, when executed by one or more processors of the base station, may cause the base station to transmit configuration information for a first timing advance timer associated with a first type of communication having a first size. The set of instructions, when executed by one or more processors of the base station, may cause the base station to receive the first type of communication based at least in part on the first timing advance timer or a second timing advance timer that is associated with a second type of communication having a size that is greater than the first size. Some aspects described herein relate to an apparatus for wireless

communication. The apparatus may include means for receiving a configuration of a first timing advance timer associated with a first type of communication having a first size. The apparatus may include means for selecting a timing advance timer from the first timing advance timer and a second timing advance timer that is associated with a second type of communication having a size that is greater than the first size. The apparatus may include means for transmitting a communication of the first type of communication based at least in part on the selected timing advance timer.

Some aspects described herein relate to an apparatus for wireless communication. The apparatus may include means for transmitting configuration information for a first timing advance timer associated with a first type of communication having a first size. The apparatus may include means for receiving the first type of communication based at least in part on the first timing advance timer or a second timing advance timer that is associated with a second type of communication having a size that is greater than the first size.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of configured grant CG communication, in accordance with the present disclosure.

FIG. 4 is a diagram illustrating an example of a two-step random access procedure, in accordance with the present disclosure.

FIG. 5 is a diagram illustrating an example of a four-step random access procedure, in accordance with the present disclosure.

FIG. 6 is a diagram illustrating an example of frame transmission using timing advance, in accordance with the present disclosure.

FIG. 7 is a diagram illustrating an example associated with handling a first timing advance timer and a second timing advance timer, in accordance with the present disclosure.

FIG. 8 is a diagram illustrating an example process associated with handling a first timing advance timer and a second timing advance timer, in accordance with the present disclosure.

FIG. 9 is a diagram illustrating an example process associated with handling a first timing advance timer and a second timing advance timer, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

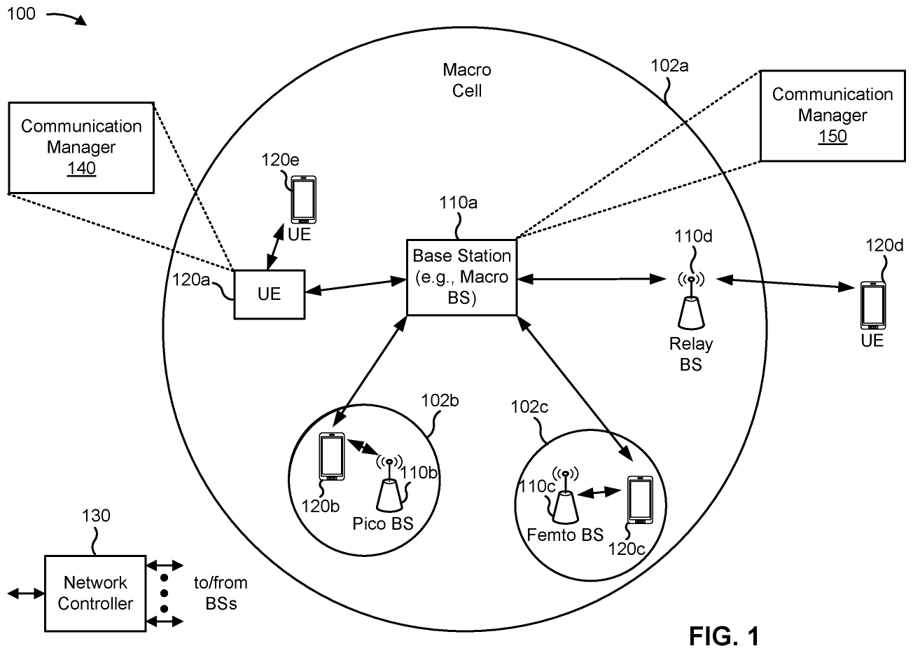

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g, three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor. a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g, which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of a first timing advance timer associated with a first type of communication having a first size; select a timing advance timer from the first timing advance timer and a second timing advance timer that is associated with a second type of communication having a size that is greater than the first size; and transmit a communication of the first type of communication based at least in part on the selected timing advance timer. Additionally, or alternatively, the communication manager 140 may perform one or more other operations described herein.

In some aspects, the base station 110 may include a communication manager 150. As described in more detail elsewhere herein, the communication manager 150 may transmit configuration information for a first timing advance timer associated with a first type of communication having a first size; and receive the first type of communication based at least in part on the first timing advance timer or a second timing advance timer that is associated with a second type of communication having a second size that is greater than the first size. Additionally, or alternatively, the communication manager 150 may perform one or more other operations described herein.

As indicated above, FIG. 1 is provided as an example. Other examples may differ from what is described with regard to FIG. 1.

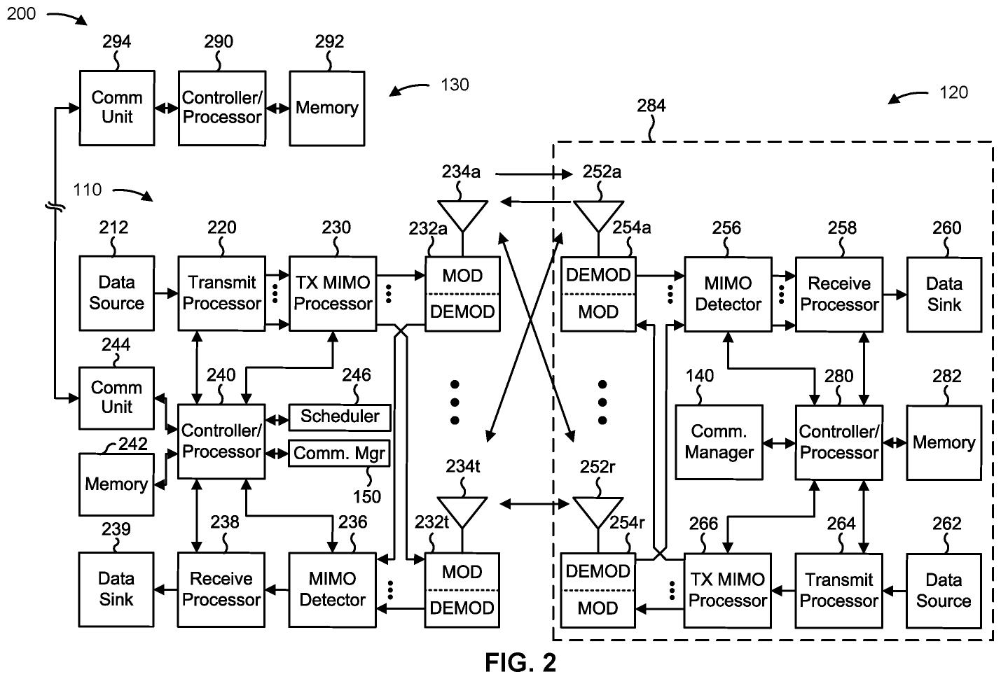

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

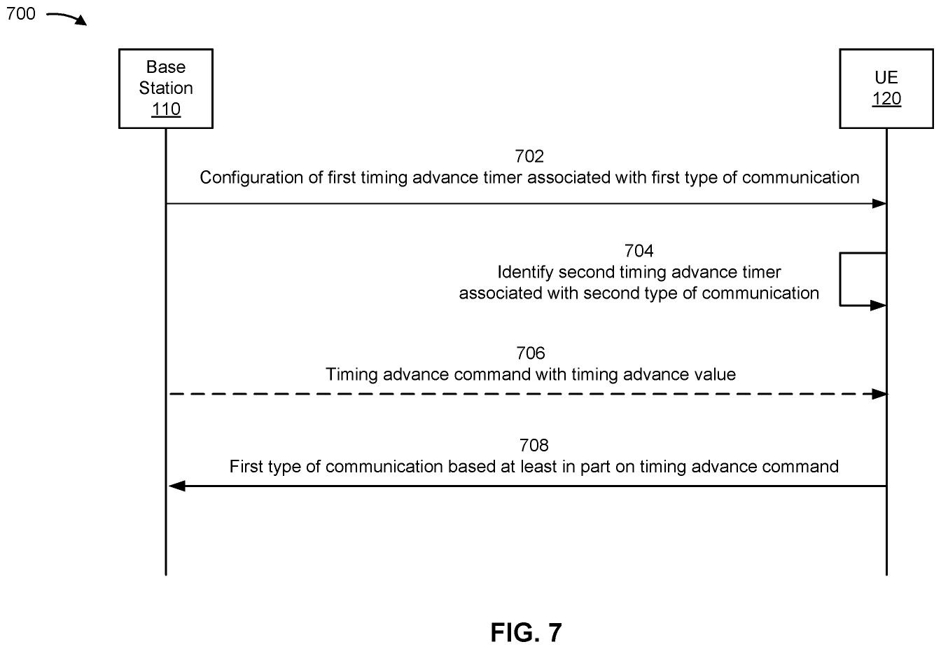

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

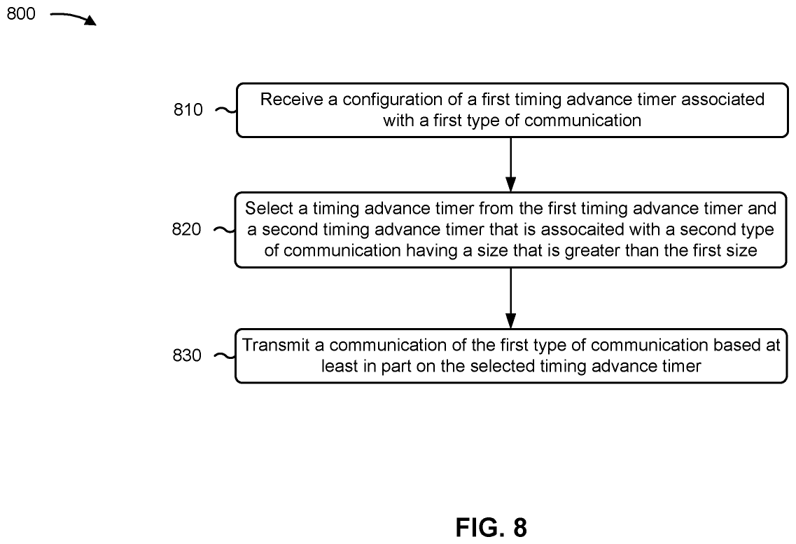

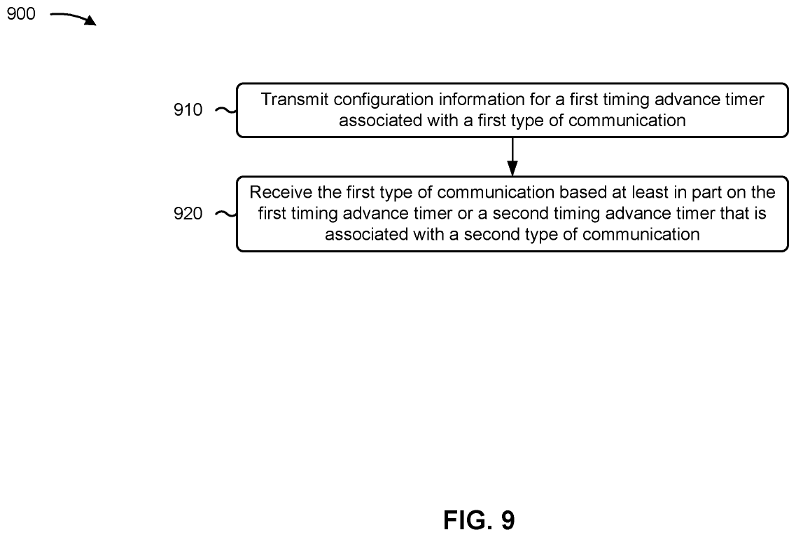

The controller/processor 240 of the base station 110, the controller/processor 280 of the UE 120, and/or any other component(s) of FIG. 2 may perform one or more techniques associated with handling a first timing advance timer and a second timing advance timer, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving a configuration of a first timing advance timer associated with a first type of communication having a first size; means for selecting a timing advance timer from the first timing advance timer and a second timing advance timer that is associated with a second type of communication having a size that is greater than the first size; and/or means for transmitting a communication of the first type of communication based at least in part on the selected timing advance timer. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting configuration information for a first timing advance timer associated with a first type of communication having a first size; and/or means for receiving the first type of communication based at least in part on the first timing advance timer or a second timing advance timer that is associated with a second type of communication having a size that is greater than the first size. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

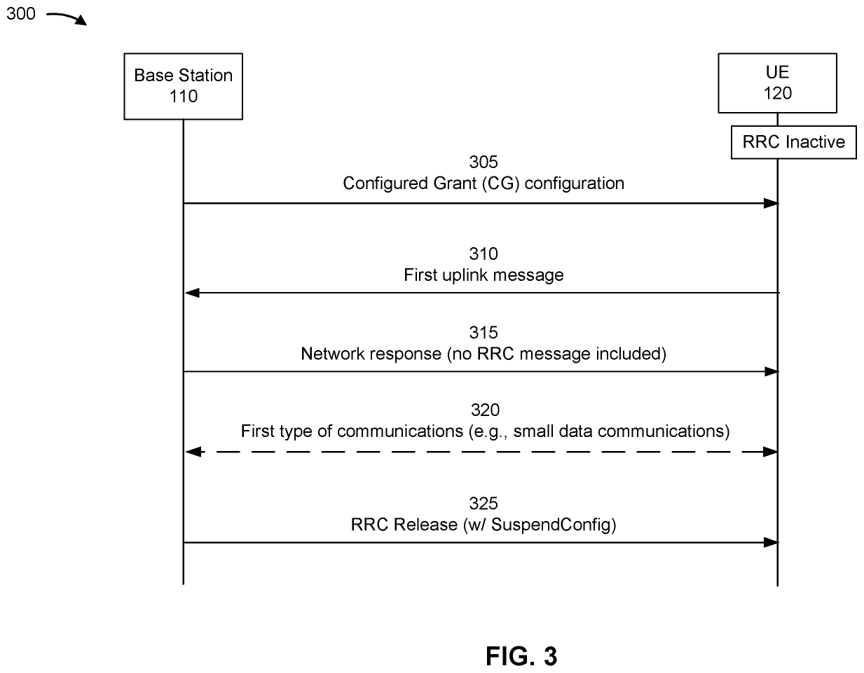

FIG. 3 is a diagram illustrating an example 300 of configured grant (CG) communication, in accordance with the present disclosure. As shown, example 300 includes a base station 110 and a UE 120.

In some cases, the configured grant may be a grant for a first type of communication having a first size. The first type of communication, which may be referred to as a “small data” communication, may include a communication of data that is less than a threshold number of bits, or that is less than or equal to the threshold number of bits. In some non-limiting examples, the first type of communication may be a communication that is less than ten bits, less than one hundred bits, or less than two hundred bits, among other examples. In some cases, the first type of communication may be a communication associated with mobile broadband or the Internet of Things (IoT), such as instant messaging software, wearable devices, etc. The base station 110 may allow the UE 120 to transmit a first type of communication in the uplink in a radio resource control (RRC) inactive state, without the UE having to move to an RRC connected state, as described in more detail below.

As shown in FIG. 3, and by reference number 305, the base station 110 may transmit a CG configuration to the UE 120. For example, the base station 110 may transmit configuration information (e.g., in an RRC message, in a downlink control information message, and/or in another signaling message) that identifies the CG. In some cases, the RRC message associated with the CG configuration may be an RRC release message (e.g., RRCRelease). The RRC release message may be used to release the RRC connection by moving the UE 120 from RRC connected state to RRC idle state, to suspend an RRC connection by moving the UE 120 from RRC connected state to an RRC inactive state, or to release an RRC connection by moving the UE 120 from an RRC inactive state to an RRC idle state. The RRC release message in the CG configuration may include a suspend configuration parameter (e.g., SuspendConfig). The suspend configuration parameter may indicate that the UE 120 should move from the RRC connected state to the RRC inactive state. In some cases, the suspend configuration parameter may indicate an inactive radio network temporary identifier (I-RNTI) that may be used to identify the UE 120 and base station 110 while the UE 120 remains within the allocated radio access network (RAN) notification area (RNA).

In some cases, the configuration information identifying the CG may indicate a resource allocation (e.g., in a time domain, frequency domain, spatial domain, and/or code domain) and/or a periodicity associated with the resource allocation. The CG may identify a resource or set of resources available to the UE 120 for transmission of an uplink communication (e.g, data and/or control information). For example, the CG configuration may identify a resource allocation for a physical uplink shared channel (PUSCH). In some cases, the CG configuration may identify a resource pool or multiple resource pools that may be available to the UE 120 for an uplink transmission.

In some cases, the CG configuration may configure contention-free CG communication with resources dedicated for the UE 120 to transmit uplink communications. In this case, the CG configuration may indicate a resource allocation (e.g., in a time domain, frequency domain, spatial domain, and/or code domain) dedicated for the UE 120 to use to transmit uplink communications. In some cases, the CG configuration may configure the resource allocation for the UE 120 to occur periodically, such that the resource allocation corresponds to periodically occurring transmission time occasions. As shown in FIG. 3, and by reference number 310, when the UE 120 has uplink data to transmit, the UE 120 transmits the uplink data in the CG resources identified by the CG configuration. For example, the UE 120 transmits the uplink data in one of the CG uplink occasions identified in the CG configuration using the configured resource allocation.

In some cases, a first uplink communication by the UE 120 (e.g., as shown by reference number 310) may include an RRC resume request message (RRCResumeReq). The RRC resume request message may be used to resume an RRC connection between the UE 120 and the base station 110. For example, the RRC resume request message may be transmitted by the UE 120 in an attempt enter (or re-enter) the RRC connected state. The RRC resume request message may include an I-RNTI and/or a medium access control (MAC) information element. The MAC information element may be used to authenticate the UE 120 before allowing the UE 120 to re-enter the RRC connected state.

As further shown in FIG. 3, and by reference number 315, the base station 110 may transmit a network response. The network response may indicate an identifier associated with the UE 120, or may indicate a timing advance value, among other examples. The network response may not include an RRC message. Thus, the UE 120 may still be in an RRC inactive state (e.g., for transmitting one or more first type of communications).

As further shown in FIG. 3, and by reference number 320, the UE 120 and the base station 110 may transmit one or more first type of communications (e.g., according to the configured grant). For example, the UE 120 may transmit one or more uplink first type of communications, and the base station 110 may transmit one or more downlink first type of communications.

As shown by reference number 325, the base station 110 may send an RRC release message, such as another RRC release message having a suspend configuration parameter, in order to end the communication session involving the first type of communications. For example, the base station 110 may send the RRC release message after the UE 120 has transmitted one or more uplink communications on the CG resources.

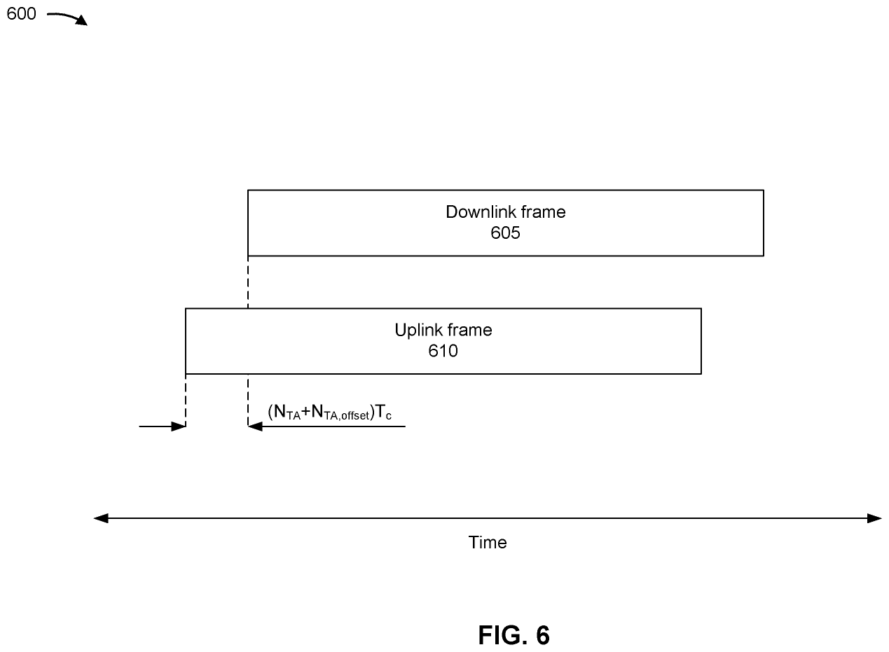

As described in more detail below, the base station 110 may transmit a timing advance command associated with the configured grant for the first type of communication. For example, the timing advance command may be sent as part of the configured grant procedure. The UE 120 may update a timing advance value used for communicating information to the base station 110 based at least in part on the timing advance command, as described in more detail in connection with FIG. 6.

As indicated above, FIG. 3 is provided as an example. Other examples may differ from what is described with respect to FIG. 3.

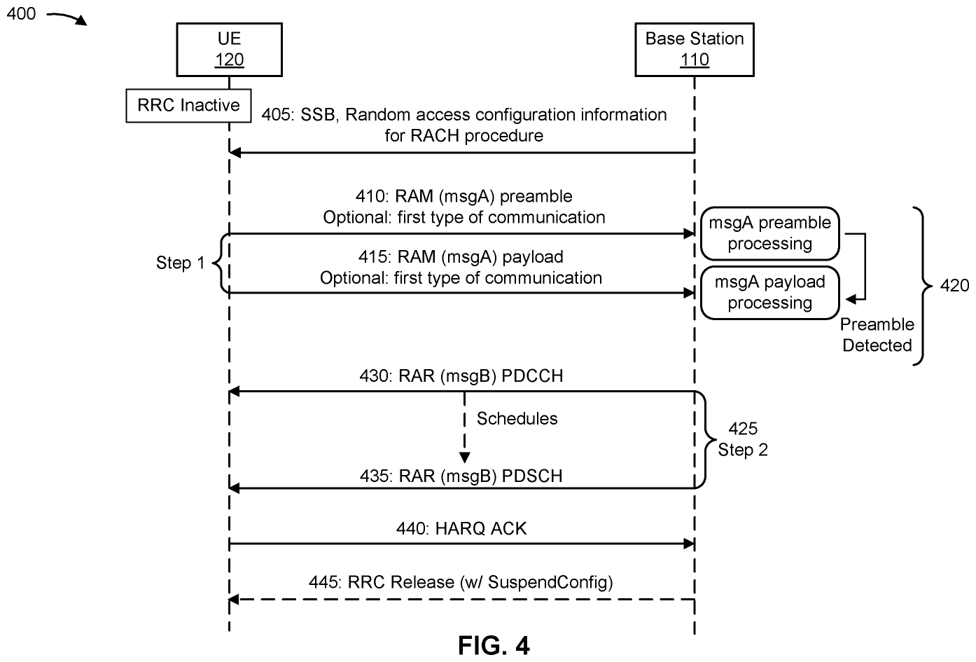

FIG. 4 is a diagram illustrating an example 400 of a two-step random access procedure, in accordance with the present disclosure. As shown in FIG. 4, a base station 110 and a UE 120 may communicate with one another to perform the two-step random access procedure.

In some cases, the UE 120 may be in an RRC inactive state (e.g., RRC_Inactive) prior to initiating the two-step random access procedure. As shown in the example 400, the UE 120 may enter the RRC inactive state based at least in part on receiving, from the base station 110, the RRC release message with the suspend configuration parameter. In some cases, the RRC inactive state may allow the UE to return to an RRC connected state and start transferring application data or signaling messages with minimal latency. The signaling load may be reduced relative to the RRC idle and RRC inactive states because the UE context is already established. The RRC inactive state may allow the UE to reduce battery power consumption relative to the RRC connected state.

As described in more detail below, the UE 120 may be configured to transmit one or more first type of communications (e.g., small data communications), after initiating, but prior to completion, of the random access procedure. For example, the UE 120 may transmit a first type of communication with the msgA (e.g., in msgA) of the two-step random access procedure. In some cases, the UE 120 may transmit the first type of communications while the UE 120 is in the RRC inactive state.

As shown by reference number 405, the base station 110 may transmit, and the UE 120 may receive, one or more SSBs and random access configuration information. In some cases, the random access configuration information may be transmitted in and/or indicated by system information (e.g., in one or more SIBs) and/or an SSB, such as for contention-based random access. Additionally, or alternatively, the random access configuration information may be transmitted in a RRC message and/or a PDCCH order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 410, the UE 120 may transmit, and the base station 110 may receive, a RAM preamble. As shown by reference number 415, the UE 120 may transmit, and the base station 110 may receive, a RAM payload. As shown, the UE 120 may transmit the RAM preamble and the RAM payload to the base station 110 as part of an initial (or first) step of the two-step random access procedure. In some cases, the RAM may be referred to as message A, msgA, a first message, or an initial message in a two-step random access procedure. Furthermore, in some cases, the RAM preamble may be referred to as a message A preamble, a msgA preamble, a preamble, or a physical random access channel (PRACH) preamble, and the RAM payload may be referred to as a message A payload, a msgA payload, or a payload. In some cases, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), and/or a physical uplink shared channel (PUSCH) transmission).

In some cases, the msgA may include uplink data as well as the RRC resume request message (RRCResumeReq), as described above in connection with FIG. 3. In some cases, the msgA may include a buffer status report (BSR) MAC CE. The BSR MAC CE may indicate an amount of data in a buffer of the UE 120 that needs to be transmitted. For example, the base station 110 may allocate a minimum uplink grant (e.g., in PUSCH) for the UE 120 to transmit the data based at least in part on receiving the BSR MAC CE.

As shown by reference number 420, the base station 110 may receive the RAM preamble transmitted by the UE 120. If the base station 110 successfully receives and decodes the RAM preamble, the base station 110 may then receive and decode the RAM payload.

As shown by reference number 425, the base station 110 may transmit a network response, such as an RAR (sometimes referred to as an RAR message). As shown, the base station 110 may transmit the RAR message as part of a second step of the two-step random access procedure. In some cases, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information. The contention resolution information may include downlink control information (DCI) with a cyclic redundancy check (CRC) scrambled by a temporary cell radio network temporary identity (TC-RNTI) scheduling a physical downlink shared channel (PDSCH) that includes a contention resolution identity for the UE 120 (e.g., to resolve a collision in which the UE 120 and another UE 120 use the same PRACH preamble in msgA). In some cases, the msgB may not include an RRC message. For example, the UE 120 may send a BSR in the msgA, and the base station 110 may schedule the UE 120 to transmit a first type of communication after the msgB contention resolution, without changing from the RRC inactive state. Instead, the RRC message may be sent after one or more first type of communications between the UE 120 and the base station 110.

As shown by reference number 430, as part of the second step of the two-step random access procedure, the base station 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication.

As shown by reference number 435, as part of the second step of the two-step random access procedure, the base station 110 may transmit the PDSCH communication for the RAR, as scheduled by the PDCCH communication. The RAR may be included in a medium access control (MAC) protocol data unit (PDU) of the PDSCH communication. As shown by reference number 440, if the UE 120 successfully receives the RAR, the UE 120 may transmit a hybrid automatic repeat request (HARQ) acknowledgement (ACK).

As shown by reference number 445, the base station 110 may send an RRC release message, such as another RRC release message having a suspend configuration parameter, in order to end the communication session. For example, the base station 110 may send the RRC release message after the completion of the random access procedure, and after the UE 120 has transmitted one or more uplink communications.

As described in more detail below, the base station 110 may transmit a timing advance command associated with the first type of communication. In some cases, the timing advance command may be sent as part of the random access procedure. The UE 120 may update a timing advance value used for communicating information to the base station 110 based at least in part on the timing advance command, as described in more detail in connection with FIG. 6.

As indicated above, FIG. 4 is provided as an example. Other examples may differ from what is described with regard to FIG. 4.

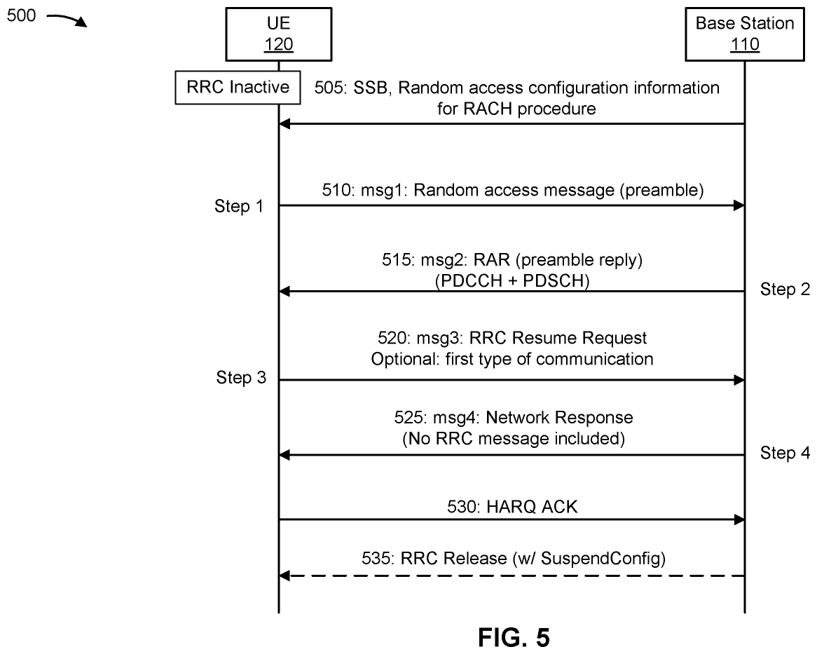

FIG. 5 is a diagram illustrating an example of a four-step random access procedure, in accordance with the present disclosure. As shown in FIG. 5, a base station 110 and a UE 120 may communicate with one another to perform the four-step random access procedure.

In some cases, the UE 120 may be in an RRC inactive state. As described above in connection with FIG. 4, the UE 120 may enter the RRC inactive state based at least in part on receiving, from the base station 110, an RRC release message with a suspend configuration parameter.

As described in more detail herein, the UE 120 may be configured to transmit one or more first type of communications (e.g., small data communications), after initiating, but prior to completion, of the random access procedure. For example, the UE 120 may transmit a first type of communication with the msg1 of the four-step random access procedure. In some cases, the UE 120 may transmit the one or more first type of communications while the UE 120 is in the RRC inactive state.

As shown by reference number 505, the base station 110 may transmit, and the UE 120 may receive, one or more SSBs and random access configuration information. In some cases, the random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 510, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the base station 110 may transmit an RAR as a reply to the preamble. The message that includes the RAR may be referred to as message 2, msg2, MSG2, or a second message in a four-step random access procedure. In some cases, the RAR may indicate the detected random access preamble identifier (e.g., received from the UE 120 in msg1). Additionally, or alternatively, the RAR may indicate a resource allocation to be used by the UE 120 to transmit message 3 (msg3). In some cases, as described in more detail below, the RAR may include a timing advance command.

In some cases, as part of the second step of the four-step random access procedure, the base station 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the base station 110 may transmit the PDSCH communication for the RAR, as scheduled by the PDCCH communication. The RAR may be included in a MAC PDU of the PDSCH communication.

As shown by reference number 520, the UE 120 may transmit an RRC resume request message. The RRC resume request message may be referred to as message 3, msg3, MSG3, or a third message of a four-step random access procedure. In some cases, the RRC resume request may include a UE identifier, a PUSCH communication, or a BSR MAC CE, among other examples.

As shown by reference number 525, the base station 110 may transmit a network response, which may be referred to as message 4, msg4, MSG4, or a fourth message of a four-step random access procedure. In some cases, the network response may include the detected UE identifier and/or contention resolution information. In some cases, the network response may not include an RRC message (as described above in FIG. 4). As shown by reference number 530, if the UE 120 successfully receives the RRC connection setup message, the UE 120 may transmit a HARQ ACK.

As shown by reference number 535, the base station 110 may send an RRC release message, such as another RRC release message having a suspend configuration parameter, in order to end the communication session. For example, the base station 110 may send the RRC release message after the completion of the random access procedure, and after the UE 120 has transmitted one or more uplink communications.

As described in more detail below, the base station 110 may transmit a timing advance command associated with the first type of communication. For example, the timing advance command may be sent as part of the random access procedure. The UE 120 may update a timing advance value used for communicating information to the base station 110 based at least in part on the timing advance command, as described in more detail in connection with FIG. 6.

As indicated above, FIG. 5 is provided as an example. Other examples may differ from what is described with regard to FIG. 5.

FIG. 6 is a diagram illustrating an example 600 of frame transmission using timing advance, in accordance with the present disclosure. The example 600 includes a downlink frame 605 and an uplink frame 610. Each of the downlink frame 605 and the uplink frame 610 may have a predetermined duration (e.g., 10 milliseconds (ms)) and may be partitioned into a set of subframes. Each subframe may have a predetermined duration (e.g., 1 ms) and may include a set of slots (e.g., 2 m slots per subframe), and each slot may include a set of L symbol periods. While FIG. 6 shows a single downlink frame 605 and a single uplink frame 610, a timing advance may be applied to any number of frames in any number of transmissions.

As shown in the example 600, the uplink frame 610 may be transmitted in accordance with a timing advance value. The timing advance value may dictate a duration (e.g., a time period) that the UE 120 delays or advances the uplink transmission to account for timing differences between the UE 120 and the base station 110, for example, due to propagation delays. This may ensure that the uplink frame 610 is received at the base station 110 when the base station 110 is expecting to receive the uplink frame 610. The timing advance value (e.g., the same timing advance value, or a different timing advance value) may be applied by the base station 110 to ensure that the downlink frame 605 is received at the UE 120 when the UE 120 is expecting to receive the downlink frame 605. In some cases, the UE 120 may receive the timing advance value as part of a timing advance command, such as a timing advance command sent from the base station 110 to the UE 120. The timing advance command may instruct the UE 120 to update the timing advance value, for example, based on movement or other propagation delays between the UE 120 and the base station 110.

In some cases, as shown in the example 600, the timing advance value applied by the UE 120 is represented by (N_{TA}+N_{TA_offset})×T_{c}, where N_{TA} is the timing advance value (e.g., sent to the UE 120 from the base station 110), N_{TA,offset} is a fixed value that varies according to different frequency bands and/or subcarrier spacings, and Tc is a physical layer time unit that is equal to (or approximately equal to) 0.509 ns.

In some cases, the UE 120 may be associated with or may store a timing advance timer. The timing advance timer may be configured (e.g., pre-configured or hard coded in memory of the UE 120, such as according to a wireless communication standard) in the UE 120. Alternatively, the timing advance timer may be received by the UE 120 from the base station 110. The timing advance timer may indicate how long the timing advance value is considered to be valid. For example, the base station 110 may transmit a timing advance command that indicates the timing advance value. Upon receipt of the timing advance command, the UE 120 may update the timing advance value, such that uplink frames 610 transmitted by the UE 120 arrive at the base station 110 at the expected time. Additionally, or alternatively, the UE 120 may restart the timing advance timer based at least in part on receiving the timing advance command, and the timing advance value may be considered to be valid until an expiration of the timing advance timer. The duration (e.g., runtime) of the timing advance timer may be stored in memory of the UE 120 and/or may be indicated in a message received from the base station 110.

As described above, the UE 120 may be configured to transmit one or more first type of communications (e.g., small data communications). In some aspects, the first type of communications may be transmitted based at least in part on a configured grant. In some aspects, the first type of communications may be transmitted after initiating, but prior to the completion of, a random access procedure, such as a two-step RACH procedure or a four-step RACH procedure. In some aspects, the UE 120 may continue to transmit one or more first type of communications after an occasion scheduled by the configured grant, or after the completion of the random access procedure. For example, the UE 120 may transmit first type of communications using a data radio bearer (DRB) associated with the first type of communications. In contrast, other communications (e.g., a second type of communications) may be transmitted using DRBs that are configured for the second type of communications.

In some cases, the UE 120 may be configured with more than one timing advance timer. For example, the UE 120 may transmit one or more first type of communications in accordance with a first timing advance timer. As described above, a first type of communication may be a communication that is less than, or less than or equal to, a threshold number of bits. In some non-limiting examples, the threshold number of bits may be ten bits, one hundred bits, or two hundred bits, among other examples. In contrast, the UE 120 may transmit one or more second type of communications in accordance with a second timing advance timer. The second type of communication may be a communication that is greater than, or greater than or equal to, the threshold number of bits. In some cases, as described in more detail below, the first type of communication may be limited to communications that are less than the threshold number of bits, and the second type of communication may be any communication having any number of bits (e.g., less than, greater than, or equal to the threshold number of bits).

In some aspects, the UE 120 may transmit first type of communications, using a timing advance value, and during a runtime of the first timing advance timer, while the UE 120 is in the RRC inactive state. In contrast, the UE 120 may transmit one or more second type of communications, using a timing advance value, and during a runtime of the second timing advance timer, while the UE 120 is in an RRC inactive state or an RRC connected state.

However, it may not always be clear which timer the UE 120 should be using at a particular time, or if the UE 120 should be using multiple timers at the same time. For example, the UE 120 may transmit the first type of communications while in an RRC inactive state. Thus, if the UE 120 receives a timing advance command while transmitting a first type of communication, but while in the RRC inactive state, the UE 120 may not know whether to use and/or restart the first timing advance timer or the second timing advance timer. In some cases, the first timing advance timer may have a different runtime than the second timing advance timer. In another example, if the UE 120 switches from the RRC inactive state to the RRC connected state while the first timing advance timer is running, the UE 120 may not know whether to stop the first timing advance timer, restart the first timing advance timer, and/or initiate the second timing advance timer. In some cases, it may not be beneficial for the UE 120 to use two separate timers simultaneously, one for the first type of communications and one for the second type of communications.

Techniques and apparatuses are described herein for timing advance using a plurality of timing advance timers. In some aspects, a UE may receive a configuration of a first timing advance timer associated with a first type of communication. The UE may select a timing advance timer from the first timing advance timer and a second timing advance timer that is associated with a second type of communication having a size that is greater than the first size, and may transmit a communication of the first type of communication in accordance with the selected timing advance timer.

As described herein, the UE may determine whether to use the first timing advance timer or the second timing advance timer for a communication session. In some aspects, the UE may determine to use the first timing advance timer or the second timing advance timer based at least in part on the UE being in an RRC inactive state. In some aspects, the UE may determine to use the first timing advance timer or the second timing advance timer based at least in part on whether the UE is transmitting according to a configured grant or a random access procedure. In some aspects, the UE may determine to use the first timing advance timer or the second timing advance timer based at least in part on whether the first timing advance timer is still running when a timing advance command is received. Various other examples are described. By selecting only one of the first timing advance timer or the second timing advance timer, based on the conditions described below, the UE may eliminate the need to use two separate timers (e.g., simultaneously) for the first type of communications.

As indicated above, FIG. 6 is provided as an example. Other examples may differ from what is described with regard to FIG. 6.

FIG. 7 is a diagram illustrating an example 700 of handling a first timing advance timer and a second timing advance timer, in accordance with the present disclosure. As shown, a base station, such as the base station 110, may communicate with a UE, such as the UE 120.

As shown in connection with reference number 702, the base station 110 may transmit, and the UE 120 may receive, a configuration of a first timing advance timer associated with a first type of communication. As described above, the first type of communication may be a communication of data that is less than a threshold number of bits, or that is less than or equal to the threshold number of bits. In some aspects, information associated with the first timing advance timer may be received from the base station 110 (e.g., in the configured grant described above). Additionally, or alternatively, information associated with the first timing advance timer may be configured (e.g., pre-configured or hard coded in memory of the UE 120, such as according to a wireless communication standard) in the UE 120.

As shown in connection with reference number 704, the UE 120 may identify a second timing advance timer associated with one or more second type of communications. As described above, the one or more second type of communications may include communications of data having any size, including communications of data that are greater than the threshold number of bits, or that are greater than or equal to the threshold number of bits. In some aspects, information associated with the second timing advance timer may be received from the base station 110. Additionally, or alternatively, information associated with the second timing advance timer may be configured (e.g., pre-configured or hard coded in memory of the UE 120, such as according to a wireless communication standard) in the UE 120.

In some aspects, both the first timing advance timer and the second timing advance timer may be used to transmit first type of communications. In some aspects, when entering the RRC inactive state, the second timing advance timer may be stopped (e.g., because the UE may not be transmitting data). Thus, the first timing advance timer may be activated (e.g., initiated) for first type of communications, as described in more detail below. In some aspects, the second timing advance timer may be used in the RRC inactive state (e.g., after completion of a random access procedure). In some aspects, the first timing advance timer may be used only for transmitting first type of communications, whereas the second timing advance timer may be used for transmitting the first type of communications and the second type of communications.

As shown in connection with reference number 706, the base station 110 may transmit, and the UE 120 may receive, a timing advance command. The timing advance command may indicate a timing advance value.

In some aspects, the UE 120 may receive the timing advance command associated with an uplink transmission of a first type of communication while the first timing advance timer is running. In this example, the UE 120 may update the timing advance value stored by the UE 120 based at least in part on the timing advance command, and may restart the first timing advance timer. In some aspects, the uplink transmission may be an uplink transmission in accordance with a configured grant for a communication session involving one or more first type of communications. As described above, the UE 120 may restart the first timing advance timer based at least in part on determining that the timing advance value received in the timing advance command will be valid for at least a full runtime of the first timing advance timer. Thus, the UE 120 may continue to transmit first type of communications, using the received timing advance value, for a duration that is based at least in part on the first timing advance timer being restarted.

In some aspects, the UE 120 may identify that the first timing advance timer has expired, and may initiate a random access (e.g., RACH) procedure. For example, the UE 120 may receive an indication that the first timing advance timer has expired, and may determine that the timing advance value is therefore no longer valid. Thus, the UE 120 may initiate the RACH procedure (e.g., to obtain a new timing advance value). In some aspects, the UE 120 may clear a configured uplink grant, flush a hybrid automatic repeat request buffer (e.g., delete all information in the buffer), and/or maintain a timing advance value (e.g., continue to store the timing advance value in memory of the UE 120 rather than delete the timing advance value from memory), based at least in part on an expiration of the first timing advance timer.

In some aspects, the UE 120 may maintain the timing advance value (e.g., at least for a time period). For example, the UE 120 may determine that the timing advance value is still accurate, or relatively accurate, because the conditions between the UE 120 and the base station 110 have not changed (or not significantly changed) since the expiration of the first timing advance timer. Thus, the UE 120 may transmit at least one first type of communication, after the expiration of the first timing advance timer, using the timing advance value.

In some aspects, the UE 120 may release the timing advance value (e.g., by deleting the timing advance value from memory of the UE 120). For example, the UE 120 may determine that the timing advance value is not accurate because the conditions between the UE 120 and the base station 110 have changed (e.g., significantly changed) since the expiration of the first timing advance timer. Thus, the UE 120 may transmit at least one first type of communication, after the expiration of the first timing advance timer, without using the timing advance value, or without using any timing advance value.

In some aspects, the UE 120 may receive the timing advance command during the RACH procedure (e.g., in msgA of the two-step RACH procedure, or msg2 RAR of the four-step RACH procedure). In some aspects, based at least in part on receiving the timing advance command, the UE 120 may update the current timing advance value stored by the UE 120, using the received timing advance value, and may initiate the second timing advance timer. In some aspects, the UE 120 may stop the second timing advance timer based at least in part on the RACH procedure being unsuccessful. For example, the UE 120 may determine not to use the second timing advance timer if the UE 120 will not be communicating with the base station 110 after the completed RACH procedure. In some aspects, based at least in part on the timing advance command, the UE 120 may update the timing advance value, using the received timing advance value, and may restart the first timing advance timer. For example, the UE 120 may restart the first timing advance timer based at least in part on determining that the UE 120 will transmit additional first type of communications after the completion of the RACH procedure. Thus, the UE 120 would not need to initiate a second timer (e.g., the second timing advance timer). In some aspects, the UE 120 may stop the first timing advance timer based at least in part on the RACH procedure being unsuccessful. For example, the UE 120 may determine not to use the first timing advance timer if the UE 120 will not be communicating with the base station 110 after the completed RACH procedure.

In some aspects, the UE 120 may initiate the RACH procedure prior to the expiration of the first timing advance timer. For example, the UE 120 may initiate the RACH procedure based at least in part on a lack of uplink resources, or a number of failed transmissions (or retransmissions) between the UE 120 and the base station 110. In this case, the UE 120 may maintain the timing advance value. For example, the UE 120 may not update the timing advance value based at least in part on the first timing advance timer still being active, which indicates that the timing advance value is still valid. In some aspects, the UE 120 may transmit at least one first type of communication, using the maintained timing advance value, after initiating the RACH procedure For example, the UF 120 may transmit the msgA associated with the two-step RACH procedure, msg3 associated with the four-step RACH procedure using the maintained timing advance value.

In some aspects, the UE 120 may receive a timing advance command during the RACH procedure. For example, the timing advance command may be received with the msg2 of the four-step RACH procedure. The timing advance command may indicate a timing advance value. In some aspects, the UE 120 may update the timing advance value using the received timing advance value, and may initiate the second timing advance timer, and stop the first timing advance timer, after successful completion of the RACH procedure. In some aspects, the UE 120 may update the timing advance value using the received timing advance value, and may restart the first timing advance timer, after successful completion of the RACH procedure.

In some aspects, the UE 120 may initiate a RACH procedure for transmitting the first type of communication. In some aspects, the UE 120 may use the first timing advance timer for the RACH procedure. For example, the UE 120 may determine that the first timing advance timer is still running, and therefore, that the timing advance value is still valid. In some aspects, the UE 120 may stop the first timing advance timer based at least in part on initiating the RACH procedure. For example, the UE 120 may stop the first timing advance timer based at least in part on determining that the UE 120 will receive an updated timing advance value during the RACH procedure. In some aspects, the UE 120 may continue to run the first timing advance timer until the UE 120 receives a timing advance command during the RACH procedure, and may stop the first timing advance timer, and start the second timing advance timer, based at least in part on receiving the timing advance command.

In some aspects, the UE 120 may receive an RRC message, associated with a switch of an RRC state, during a first type of communication session. For example, the RRC message may be the RRC resume message, and the switch to the RRC state may be a switch to the RRC connected state, as described above in connection with FIG. 3. In some aspects, the UE 120 may stop the first timing advance timer, and may initiate the second timing advance timer, based at least in part on being in the RRC connected state. In some aspects, the UE 120 may be configured to transmit one or more second type of communications, while in the RRC connected state, and using a timing advance value in accordance with the second timing advance timer.

In some aspects, the RRC message may not include a timing advance command. In this example, the UF 120 may start the second timing advance timer, and may use a timing advance value that is stored by the UE 120. In some aspects, the RRC message may include a timing advance command. In this example, the UE 120 may update a timing advance value based at least in part on the received timing advance command, and may start the second timing advance timer. In some aspects, the UE 120 may transmit an acknowledgement (ACK) message to the base station 110 based at least in part on receiving the RRC message. The base station 110, after receiving the ACK message, may transmit a timing advance command. In this example, the UE may update the timing advance value based at least in part on the timing advance command, and may start the second timing advance timer.

In some aspects, the UE 120 may receive an RRC message at an end of a transmission session involving one or more first type of communications (e.g., in the msg4 or msgB). The RRC message may indicate a switch to a connected state. The UE 120, based at least in part on receiving the RRC message, may stop the first timing advance timer based at least in part on receiving the RRC message at the end of the communication session, and may initiate the second timing advance timer. For example, the UE 120 may stop the first timing advance timer, and initiate the second timing advance timer, based at least in part on the UE 120 being in the RRC connected state.

As shown in connection with reference number 708, the UE 120 may transmit, and the base station 110 may receive, a first type of communication based at least in part on the timing advance command. The first type of communication may be transmitted based at least in part on the first timing advance timer or the second timing advance timer. For example, the first type of communication may be transmitted using a timing advance value, such as a configured timing advance value, a first received timing advance value, or an updated timing advance value (e.g., received in a timing advance command). The UE 120 may transmit the first type of communications using the timing advance value for the duration of the selected first timing advance timer or the second timing advance timer, thereby eliminating the need to use two separate timers, and the need to switch between those two separate timers, for first type of communications and second type of communications.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with handling a first timing advance timer and a second timing advance timer.

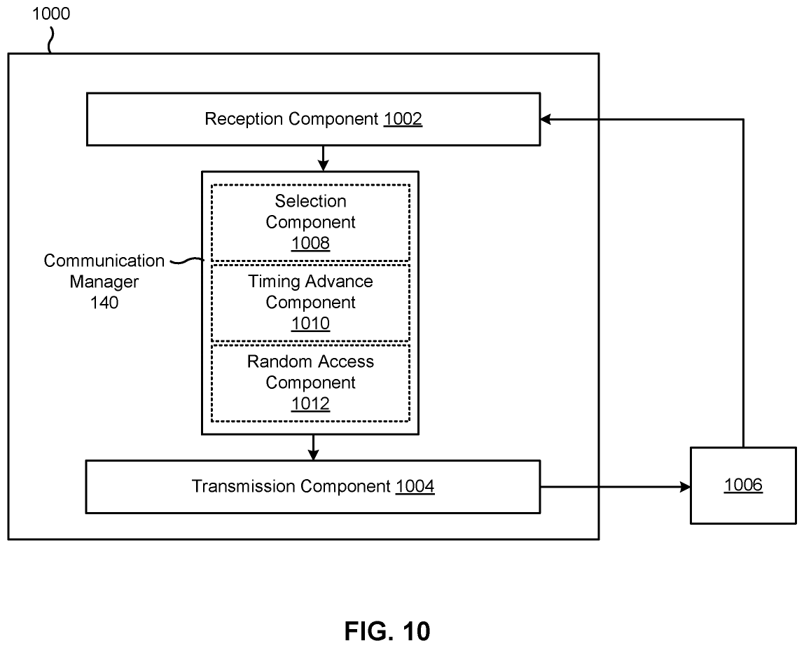

As shown in FIG. 8, in some aspects, process 800 may include receiving a configuration of a first timing advance timer associated with a first type of communication having a first size (block 810). For example, the UE (e.g., using communication manager 140 and/or reception component 1002, depicted in FIG. 10) may receive a configuration of a first timing advance timer associated with a first type of communication, as described above.

As shown in FIG. 8, in some aspects, process 800 may include selecting a timing advance timer from the first timing advance timer and a second timing advance timer that is associated with a second type of communication having a size that is greater than the first size (block 820). For example, the UE (e.g., using communication manager 140 and/or reception component 1002, depicted in FIG. 10) may select a timing advance timer from the first timing advance timer and the second timing advance timer, as described above.

As further shown in FIG. 8, in some aspects, process 800 may include transmitting a communication of the first type of communication based at least in part on the selected timing advance timer (block 830). For example, the UE (e.g., using communication manager 140 and/or transmission component 1004, depicted in FIG. 10) may transmit the first type of communication based at least in part on the selected timing advance timer, as described above.

Process 800 may include additional aspects, such as any single aspect or any combination of aspects described below and/or in connection with one or more other processes described elsewhere herein.

In a first aspect, the first type of communication is a communication of data that is less than a threshold number of bits or that is less than or equal to the threshold number of bits.

In a second aspect, alone or in combination with the first aspect, each communication of the one or more second type of communications includes a communication of data that is greater than the threshold number of bits or that is greater than or equal to the threshold number of bits.

In a third aspect, alone or in combination with one or more of the first and second aspects, process 800 includes receiving a timing advance command associated with an uplink transmission of the first type of communication while the first timing advance timer is running, updating a timing advance value stored by the UE based at least in part on the timing advance command, and restarting the first timing advance timer based at least in part on the timing advance command.

In a fourth aspect, alone or in combination with one or more of the first through third aspects, process 800 includes receiving an indication associated with an expiration of the first timing advance timer, initiating a RACH procedure based at least in part on the indication of the expiration of the first timing advance timer, and receiving a timing advance command during the RACH procedure.

In a fifth aspect, alone or in combination with one or more of the first through fourth aspects, process 800 includes identifying the second timing advance timer, initiating the second timing advance timer, and updating a timing advance value, based at least in part on the timing advance command.

In a sixth aspect, alone or in combination with one or more of the first through fifth aspects, process 800 includes stopping the second timing advance timer based at least in part on the RACH procedure being unsuccessful.

In a seventh aspect, alone or in combination with one or more of the first through sixth aspects, process 800 includes restarting the first timing advance timer, and updating a timing advance value, based at least in part on the timing advance command.

In an eighth aspect, alone or in combination with one or more of the first through seventh aspects, process 800 includes stopping the first timing advance timer based at least in part on the RACH procedure being unsuccessful.

In a ninth aspect, alone or in combination with one or more of the first through eighth aspects, initiating the RACH procedure comprises maintaining the timing advance value for at least one first type of communication.

In a tenth aspect, alone or in combination with one or more of the first through ninth aspects, initiating the RACH procedure comprises releasing the timing advance value for at least one first type of communication.

In an eleventh aspect, alone or in combination with one or more of the first through tenth aspects, process 800 includes initiating a RACH procedure prior to an expiration of the first timing advance timer, and maintaining a timing advance value stored by the UE based at least in part on initiating the RACH procedure.

In a twelfth aspect, alone or in combination with one or more of the first through eleventh aspects, process 800 includes receiving a timing advance command during the RACH procedure, and transmitting, after receiving the timing advance command, at least one first type of communication using the maintained timing advance value.

In a thirteenth aspect, alone or in combination with one or more of the first through twelfth aspects, process 800 includes identifying the second timing advance timer, initiating the second timing advance timer, stopping the first timing advance timer, and updating the timing advance value, after successful completion of the RACH procedure.

In a fourteenth aspect, alone or in combination with one or more of the first through thirteenth aspects, process 800 includes restarting the first timing advance timer, and updating the timing advance value, after successful completion of the RACH procedure.

In a fifteenth aspect, alone or in combination with one or more of the first through fourteenth aspects, process 800 includes initiating a random access channel (RACH) procedure for transmitting the first type of communication.

In a sixteenth aspect, alone or in combination with one or more of the first through fifteenth aspects, process 800 includes using the first timing advance timer for the RACH procedure.

In a seventeenth aspect, alone or in combination with one or more of the first through sixteenth aspects, process 800 includes stopping the first timing advance timer based at least in part on initiating the RACH procedure.

In an eighteenth aspect, alone or in combination with one or more of the first through seventeenth aspects, process 800 includes continuing to run the first timing advance timer until the UE receives a timing advance command during the RACH procedure, and stopping the first timing advance timer, and starting the second timing advance timer, based at least in part on receiving the timing advance command.

In a nineteenth aspect, alone or in combination with one or more of the first through eighteenth aspects, process 800 includes receiving a radio resource control (RRC) message, associated with a switch of an RRC state, during a communication session involving one or more first type of communications, and stopping the first timing advance timer based at least in part on receiving the RRC message.

In a twentieth aspect, alone or in combination with one or more of the first through nineteenth aspects, process 800 includes starting the second timing advance timer, and using a timing advance value that is stored by the UE, based at least in part on receiving the RRC message.

In a twenty-first aspect, alone or in combination with one or more of the first through twentieth aspects, process 800 includes updating a timing advance value based at least in part on a timing advance command received in the RRC message, and starting the second timing advance timer based at least in part on receiving the RRC message.

In a twenty-second aspect, alone or in combination with one or more of the first through twenty-first aspects, process 800 includes transmitting an acknowledgement (ACK) message based at least in part on receiving the RRC message, receiving a timing advance command after transmitting the ACK message, and updating a timing advance value, and starting a second timing advance timer, based at least in part on the timing advance command.

In a twenty-third aspect, alone or in combination with one or more of the first through twenty-second aspects, the communication session is associated with a configured grant for transmitting first type of communications, or a random access channel (RACH) procedure.

In a twenty-fourth aspect, alone or in combination with one or more of the first through twenty-third aspects, process 800 includes receiving a radio resource control (RRC) message, indicating a switch to a connected state, at an end of a communication session involving one or more first type of communications, stopping the first timing advance timer based at least in part on receiving the RRC message at the end of the communication session, and initiating the second timing advance timer based at least in part on receiving the RRC message at the end of the communication session.

In a twenty-fifth aspect, alone or in combination with one or more of the first through twenty-fourth aspects, process 800 includes at least one of clearing a configured uplink grant, flushing a hybrid automatic repeat request buffer, or maintaining a timing advance value based at least in part on an expiration of the first timing advance timer.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with handling a first timing advance timer and a second timing advance timer.

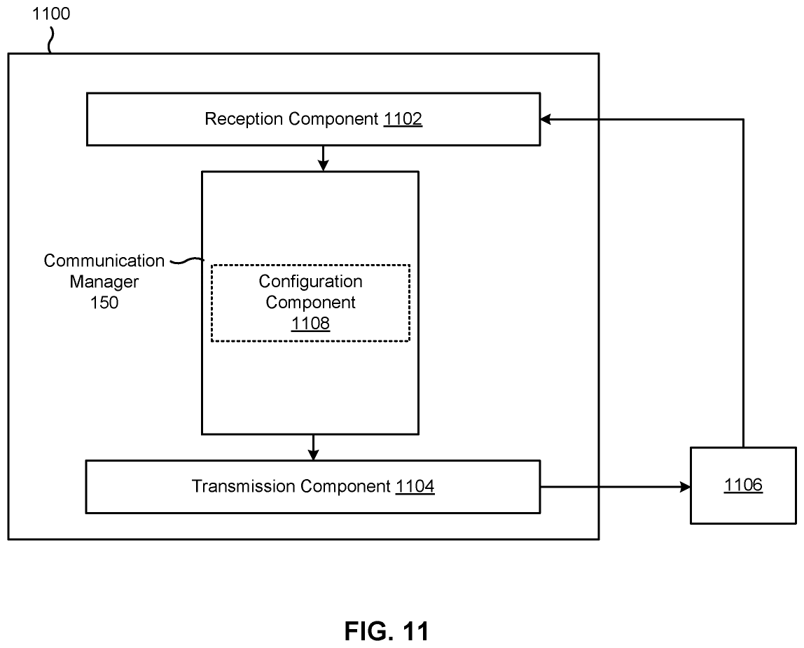

As shown in FIG. 9, in some aspects, process 900 may include transmitting configuration information for a first timing advance timer associated with a first type of communication having a first size (block 910). For example, the base station (e.g., using communication manager 150 and/or transmission component 1104, depicted in FIG. 11) may transmit configuration information for a first timing advance timer associated with a first type of communication, as described above.

As further shown in FIG. 9, in some aspects, process 900 may include receiving the first type of communication based at least in part on the first timing advance timer or a second timing advance timer that is associated with a second type of communication having a size that is greater than the first size (block 920). For example, the base station (e.g., using communication manager 150 and/or reception component 1102, depicted in FIG. 10) may receive the first type of communication based at least in part on the first timing advance timer or a second timing advance timer that is associated with the second type of communication, as described above.

Process 900 may include additional aspects, such as any single aspect or any combination of aspects described below and/or in connection with one or more other processes described elsewhere herein.

In a first aspect, the first type of communication is a communication of data that is less than a threshold number of bits or that is less than or equal to the threshold number of bits.

In a second aspect, alone or in combination with the first aspect, each communication of the one or more second type of communications includes a communication of data that is greater than the threshold number of bits or that is greater than or equal to the threshold number of bits.

In a third aspect, alone or in combination with one or more of the first and second aspects, process 900 includes transmitting a timing advance command associated with a configured grant for the first type of communication, and receiving the first type of communication according to a timing advance value indicated in the timing advance command.

In a fourth aspect, alone or in combination with one or more of the first through third aspects, process 900 includes transmitting a timing advance command associated with a RACH procedure for the first type of communication, and receiving the first type of communication according to a timing advance value indicated in the timing advance command.

In a fifth aspect, alone or in combination with one or more of the first through fourth aspects, the RACH procedure is a RACH procedure specific to the first type of communication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a selection component 1008, a timing advance component 1010, or a random access component 1012, among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive a configuration of a first timing advance timer associated with a first type of communication having a first size. The selection component 1008 may select a timing advance timer from the first timing advance timer and a second timing advance timer that is associated with a second type of communication having a size that is greater than the first size. The transmission component 1004 may transmit a communication of the first type of communication based at least in part on the selected timing advance timer.

The reception component 1002 may receive a timing advance command associated with an uplink transmission of the first type of communication while the first timing advance timer is running. The timing advance component 1010 may update a timing advance value stored by the UE based at least in part on the timing advance command, and may restart the first timing advance timer based at least in part on the timing advance command.

The reception component 1002 may receive an indication associated with an expiration of the first timing advance timer. The random access component 1012 may initiate a random access channel (RACH) procedure based at least in part on the indication of the expiration of the first timing advance timer. The reception component 1002 may receive a timing advance command during the RACH procedure.

The timing advance component 1010 may initiate the second timing advance timer, and update a timing advance value, based at least in part on the timing advance command. The timing advance component 1010 may stop the second timing advance timer based at least in part on the RACH procedure being unsuccessful.

The timing advance component 1010 may restart the first timing advance timer, and updating a timing advance value, based at least in part on the timing advance command. The timing advance component 1010 may stop the first timing advance timer based at least in part on the RACH procedure being unsuccessful.

The timing advance component 1010 may initiate a random access channel (RACH) procedure prior to an expiration of the first timing advance timer. The timing advance component 1010 may maintain a timing advance value stored by the UE based at least in part on initiating the RACH procedure.

The reception component 1002 may receive a timing advance command during the RACH procedure. The transmission component 1004 may transmit, after receiving the timing advance command, at least one first type of communication using the maintained timing advance value.

The timing advance component 1010 may initiate the second timing advance timer, stopping the first timing advance timer, and updating the timing advance value, after successful completion of the RACH procedure.

The timing advance component 1010 may restart the first timing advance timer, and updating the timing advance value, after successful completion of the RACH procedure.

The timing advance component 1010 may initiate a random access channel (RACH) procedure for transmitting the first type of communication. The timing advance component 1010 may use the first timing advance timer for the RACH procedure The timing advance component 1010 may stop the first timing advance timer based at least in part on initiating the procedure. The timing advance component 1010 may continue to run the first timing advance timer until the UE receives a timing advance command during the RACH procedure. The timing advance component 1010 may stop the first timing advance timer, and starting the second timing advance timer, based at least in part on receiving the timing advance command.

The reception component 1002 may receive a radio resource control (RRC) message, associated with a switch of an RRC state, during a communication session involving one or more first type of communication. The timing advance component 1010 may stop the first timing advance timer based at least in part on receiving the RRC message.

The timing advance component 1010 may start the second timing advance timer, and using a timing advance value that is stored by the UE, based at least in part on receiving the RRC message.

The timing advance component 1010 may update a timing advance value based at least in part on a timing advance command received in the RRC message. The timing advance component 1010 may start the second timing advance timer based at least in part on receiving the RRC message.

The transmission component 1004 may transmit an acknowledgement (ACK) message based at least in part on receiving the RRC message. The reception component 1002 may receive a timing advance command after transmitting the ACK message. The timing advance component 1010 may update a timing advance value, and starting a second timing advance timer, based at least in part on the timing advance command.

The reception component 1002 may receive a radio resource control (RRC) message, indicating a switch to a connected state, at an end of a communication session involving one or more first type of communications. The timing advance component 1010 may stop the first timing advance timer based at least in part on receiving the RRC message at the end of the communication session. The timing advance component 1010 may initiate the second timing advance timer based at least in part on receiving the RRC message at the end of the communication session.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a configuration component 1108, among other examples.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The transmission component 1104 may transmit configuration information for a first timing advance timer associated with a first type of communication having a first size. The reception component 1102 may receive the first type of communication based at least in part on the first timing advance timer or a second timing advance timer that is associated with a second type of communication having a size that is greater than the first size.

The transmission component 1104 may transmit a timing advance command associated with a configured grant for the first type of communication, and the reception component 1102 may receive the first type of communication according to a timing advance value indicated in the timing advance command.

The transmission component 1104 may transmit a timing advance command associated with a random access channel (RACH) procedure for the first type of communication, and the reception component 1102 may receive the first type of communication according to a timing advance value indicated in the timing advance command.

The configuration component 1108 may transmit configuration information, such as configuration information associated with the first timing advance timer or the second timing advance timer, among other examples, to the UE 120.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a configuration of a first timing advance timer associated with a first type of communication having a first size: selecting a timing advance timer from the first timing advance timer and a second timing advance timer that is associated with a second type of communication having a size that is greater than the first size; and transmitting a communication of the first type of communication based at least in part on the selected timing advance timer.

Aspect 2: The method of Aspect 1, wherein the first type of communication is a communication of data that is less than a threshold number of bits or that is less than or equal to the threshold number of bits.

Aspect 3: The method of any of Aspects 1-2, wherein each communication of the one or more second type of communications includes a communication of data that is greater than the threshold number of bits or that is greater than or equal to the threshold number of bits.

Aspect 4: The method of any of Aspects 1-3, further comprising: receiving a timing advance command associated with an uplink transmission of the first type of communication while the first timing advance timer is running; updating a timing advance value stored by the UE based at least in part on the timing advance command; and restarting the first timing advance timer based at least in part on the timing advance command.

Aspect 5: The method of any of Aspects 1-3, further comprising: receiving an indication associated with an expiration of the first timing advance timer; initiating a random access channel (RACH) procedure based at least in part on the indication of the expiration of the first timing advance timer; and receiving a timing advance command during the RACH procedure.

Aspect 6: The method of Aspect 5, further comprising: initiating the second timing advance timer, and updating a timing advance value, based at least in part on the timing advance command.

Aspect 7: The method of Aspect 6, further comprising: stopping the second timing advance timer based at least in part on the RACH procedure being unsuccessful.

Aspect 8: The method of Aspect 5, further comprising: restarting the first timing advance timer, and updating a timing advance value, based at least in part on the timing advance command.

Aspect 9: The method of Aspect 8, further comprising: stopping the first timing advance timer based at least in part on the RACH procedure being unsuccessful.

Aspect 10: The method of Aspect 5, wherein initiating the RACH procedure comprises maintaining the timing advance value for at least one first type of communication.

Aspect 11: The method of Aspect 5, wherein initiating the RACH procedure comprises releasing the timing advance value for at least one first type of communication.

Aspect 12: The method of any of Aspects 1-3, further comprising: initiating a random access channel (RACH) procedure prior to an expiration of the first timing advance timer; and maintaining a timing advance value stored by the UE based at least in part on initiating the RACH procedure.

Aspect 13: The method of Aspect 12, further comprising: receiving a timing advance command during the RACH procedure; and transmitting, after receiving the timing advance command, at least one first type of communication using the maintained timing advance value.

Aspect 14: The method of Aspect 13, further comprising: initiating the second timing advance timer, stopping the first timing advance timer, and updating the timing advance value, after successful completion of the RACH procedure.

Aspect 15: The method of Aspect 13, further comprising: restarting the first timing advance timer, and updating the timing advance value, after successful completion of the RACH procedure.

Aspect 16: The method of any of Aspects 1-15, further comprising initiating a random access channel (RACH) procedure for transmitting the first type of communication.

Aspect 17: The method of Aspect 16, further comprising using the first timing advance timer for the RACH procedure.

Aspect 18: The method of Aspect 16, further comprising stopping the first timing advance timer based at least in part on initiating the RACH procedure.

Aspect 19: The method of Aspect 16, further comprising: continuing to run the first timing advance timer until the UE receives a timing advance command during the RACH procedure; and stopping the first timing advance timer, and starting the second timing advance timer, based at least in part on receiving the timing advance command.

Aspect 20: The method of any of Aspects 1-19, further comprising: receiving a radio resource control (RRC) message, associated with a switch of an RRC state, during a communication session involving the first type of communication; and stopping the first timing advance timer based at least in part on receiving the RRC message.

Aspect 21: The method of Aspect 20, further comprising starting the second timing advance timer, and using a timing advance value that is stored by the UE, based at least in part on receiving the RRC message.

Aspect 22: The method of Aspect 20, further comprising: updating a timing advance value based at least in part on a timing advance command received in the RRC message; and starting the second timing advance timer based at least in part on receiving the RRC message.

Aspect 23: The method of Aspect 20, further comprising: transmitting an acknowledgement (ACK) message based at least in part on receiving the RRC message; receiving a timing advance command after transmitting the ACK message; and updating a timing advance value, and starting a second timing advance timer, based at least in part on the timing advance command.

Aspect 24: The method of Aspect 20, wherein the communication session is associated with a configured grant for transmitting first type of communications, or a random access channel (RACH) procedure.

Aspect 25: The method of any of Aspects 1-24, further comprising: receiving a radio resource control (RRC) message, indicating a switch to a connected state, at an end of a communication session involving one or more first type of communications; stopping the first timing advance timer based at least in part on receiving the RRC message at the end of the communication session; and initiating the second timing advance timer based at least in part on receiving the RRC message at the end of the communication session.

Aspect 26: The method of any of Aspects 1-25, further comprising at least one of clearing a configured uplink grant, flushing a hybrid automatic repeat request buffer, or maintaining a timing advance value based at least in part on an expiration of the first timing advance timer.

Aspect 27: A method of wireless communication performed by a base station, comprising: transmitting configuration information for a first timing advance timer associated with a first type of communication having a first size; and receiving the first type of communication based at least in part on the first timing advance timer or a second timing advance timer that is associated with a second type of communication having a size that is greater than the first size.

Aspect 28: The method of Aspect 27, wherein the first type of communication is a communication of data that is less than a threshold number of bits or that is less than or equal to the threshold number of bits.

Aspect 29: The method of any of Aspects 27-28, wherein each communication of the one or more second type of communications includes a communication of data that is greater than the threshold number of bits or that is greater than or equal to the threshold number of bits.

Aspect 30: The method of any of Aspects 27-29, further comprising: transmitting a timing advance command associated with a configured grant for the first type of communication; and receiving the first type of communication according to a timing advance value indicated in the timing advance command.

Aspect 31: The method of any of Aspects 27-29, further comprising: transmitting a timing advance command associated with a random access channel (RACH) procedure for the first type of communication; and receiving the first type of communication according to a timing advance value indicated in the timing advance command.

Aspect 32: The method of Aspect 31, wherein the RACH procedure is a RACH procedure that is specific to the first type of communication.

Aspect 33: An apparatus for wireless communication at a device, comprising a processor; memory coupled with the processor; and instructions stored in the memory and executable by the processor to cause the apparatus to perform the method of one or more of Aspects 1-26.

Aspect 34: A device for wireless communication, comprising a memory and one or more processors coupled with the memory, the one or more processors configured to perform the method of one or more of Aspects 1-26.

Aspect 35: An apparatus for wireless communication, comprising at least one means for performing the method of one or more of Aspects 1-26.

Aspect 36: A non-transitory computer-readable medium storing code for wireless communication, the code comprising instructions executable by a processor to perform the method of one or more of Aspects 1-26.

Aspect 37: A non-transitory computer-readable medium storing a set of instructions for wireless communication, the set of instructions comprising one or more instructions that, when executed by one or more processors of a device, cause the device to perform the method of one or more of Aspects 1-26.

Aspect 38: An apparatus for wireless communication at a device, comprising a processor; memory coupled with the processor; and instructions stored in the memory and executable by the processor to cause the apparatus to perform the method of one or more of Aspects 27-32.

Aspect 39: A device for wireless communication, comprising a memory and one or more processors coupled with the memory, the one or more processors configured to perform the method of one or more of Aspects 27-32.

Aspect 40: An apparatus for wireless communication, comprising at least one means for performing the method of one or more of Aspects 27-32.

Aspect 41: A non-transitory computer-readable medium storing code for wireless communication, the code comprising instructions executable by a processor to perform the method of one or more of Aspects 27-32.

Aspect 42: A non-transitory computer-readable medium storing a set of instructions for wireless communication, the set of instructions comprising one or more instructions that, when executed by one or more processors of a device, cause the device to perform the method of one or more of Aspects 27-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled with the memory, configured to:
receive a configuration of a first timing advance timer associated with a first type of communication having a first size;
select a timing advance timer from the first timing advance timer and a second timing advance timer that is associated with a second type of communication having a size that is greater than the first size; and
transmit a communication of the first type of communication based at least in part on the selected timing advance timer.

2. The apparatus of claim 1, wherein the first type of communication is a communication of data that is less than a threshold number of bits or that is less than or equal to the threshold number of bits.

3. The apparatus of claim 1, wherein the one or more processors are further configured to:
receive a timing advance command associated with an uplink transmission of the first type of communication while the first timing advance timer is running;
update a timing advance value stored by the UE based at least in part on the timing advance command; and
restart the first timing advance timer based at least in part on the timing advance command.

4. The apparatus of claim 1, wherein the one or more processors are further configured to:
receive an indication associated with an expiration of the first timing advance timer;
initiate a random access channel (RACH) procedure based at least in part on the indication of the expiration of the first timing advance timer; and
receive a timing advance command during the RACH procedure.

5. The apparatus of claim 4, wherein the one or more processors are further configured to:
initiate the second timing advance timer, and update a timing advance value, based at least in part on the timing advance command.

6. The apparatus of claim 4, wherein the one or more processors are further configured to:
restart the first timing advance timer, and update a timing advance value, based at least in part on the timing advance command.

7. The apparatus of claim 1, wherein the one or more processors are further configured to:
initiate a random access channel (RACH) procedure prior to an expiration of the first timing advance timer; and
maintain a timing advance value stored by the UE based at least in part on initiating the RACH procedure.

8. The apparatus of claim 7, wherein the one or more processors are further configured to:
receive a timing advance command during the RACH procedure; and
transmit, after receiving the timing advance command, at least one first type of communication using the maintained timing advance value.

9. The apparatus of claim 8, wherein the one or more processors are further configured to:
initiate the second timing advance timer, stop the first timing advance timer, and update the timing advance value, after successful completion of the RACH procedure.

10. The apparatus of claim 8, wherein the one or more processors are further configured to:
restart the first timing advance timer, and update the timing advance value, after successful completion of the RACH procedure.

11. The apparatus of claim 1, wherein the one or more processors are further configured to initiate a random access channel (RACH) procedure for transmitting the first type of communication.

12. The apparatus of claim 11, wherein the one or more processors are further configured to use the first timing advance timer for the RACH procedure.

13. The apparatus of claim 11, wherein the one or more processors are further configured to stop the first timing advance timer based at least in part on initiating the RACH procedure.

14. The apparatus of claim 11, wherein the one or more processors are further configured to:
continue to run the first timing advance timer until the UE receives a timing advance command during the RACH procedure; and
stop the first timing advance timer, and start the second timing advance timer, based at least in part on receiving the timing advance command.

15. The apparatus of claim 1, wherein the one or more processors are further configured to:
receive a radio resource control (RRC) message, associated with a switch of an RRC state, during a communication session involving one or more of the first type of communications; and
stop the first timing advance timer based at least in part on receiving the RRC message.

16. An apparatus for wireless communication at a base station, comprising:
a memory; and
one or more processors, coupled with the memory, configured to:
transmit configuration information for a first timing advance timer associated with a first type of communication having a first size; and
receive the first type of communication based at least in part on the first timing advance timer or a second timing advance timer that is associated with a second type of communication having a size that is greater than the first size.

17. The apparatus of claim 16, wherein the first type of communication is a communication of data that is less than a threshold number of bits or that is less than or equal to the threshold number of bits.

18. A method of wireless communication performed by a user equipment (UE), comprising:
receiving a configuration of a first timing advance timer associated with a first type of communication having a first size;
selecting a timing advance timer from the first timing advance timer and a second timing advance timer that is associated with a second type of communication having a size that is greater than the first size; and
transmitting a communication of the first type of communication based at least in part on the selected timing advance timer.

19. The method of claim 18, wherein the first type of communication is a communication of data that is less than a threshold number of bits or that is less than or equal to the threshold number of bits.

20. The method of claim 18, further comprising:
receiving a timing advance command associated with an uplink transmission of the first type of communication while the first timing advance timer is running;
updating a timing advance value stored by the UE based at least in part on the timing advance command; and
restarting the first timing advance timer based at least in part on the timing advance command.

21. The method of claim 18, further comprising:
receiving an indication associated with an expiration of the first timing advance timer;
initiating a random access channel (RACH) procedure based at least in part on the indication of the expiration of the first timing advance timer; and
receiving a timing advance command during the RACH procedure.

22. The method of claim 18, further comprising:
initiating a random access channel (RACH) procedure prior to an expiration of the first timing advance timer; and
maintaining a timing advance value stored by the UE based at least in part on initiating the RACH procedure.

23. The method of claim 18, further comprising:
receiving a radio resource control (RRC) message, associated with a switch of an RRC state, during a communication session involving one or more of the first type of communications; and
stopping the first timing advance timer based at least in part on receiving the RRC message.

24. A method of wireless communication performed by a base station, comprising:
transmitting configuration information for a first timing advance timer associated with a first type of communication having a first size; and
receiving the first type of communication based at least in part on the first timing advance timer or a second timing advance timer that is associated with a second type of communication having a size that is greater than the first size.

25. The method of claim 24, wherein the first type of communication is a communication of data that is less than a threshold number of bits or that is less than or equal to the threshold number of bits.
